(19) United States
(12) Patent Application Publication
(10) Pub. No.: US 2003/0105739 A1
(43) Pub. Date: Jun. 5, 2003

(54) Method and a system for identifying and verifying the content of multimedia documents

(76) Inventors: Hassane Essafi, Orsay (FR); Marc Pic, Paris (FR)

Correspondence Address: WEINGARTEN, SCHURGIN, GAGNEBIN & LEBOVICI LLP, TEN POST OFFICE SQUARE, BOSTON, MA, 02109, US

(21) Appl. No.: 10/270,251

(22) Filed: Oct. 11, 2002

Related U.S. Application Data
(60) Provisional application No. 60/377,121, filed on May 2, 2002.

(30) Foreign Application Priority Data
Oct. 12, 2001 (FR) 01 13224

(51) Int. Cl. G06F 7/00

(52) U.S. Cl. 707/1

(57) ABSTRACT

A method of identifying and verifying the content of multimedia documents accessible in a distributed system having multiple entry points, the method comprises: a) a step of registering multimedia documents as identified works, the registration step comprising, for each multimedia document under consideration, extracting a digital fingerprint comprising an ordered sequence of signatures in cascade resulting from multi-criterion analysis and breaking down into component parts of the multimedia document under consideration; and b) a step of verifying whether a given multimedia document accessible to the public constitutes authorized or unauthorized use of a registered work, the verification step comprising making successive comparisons using the signatures in cascade of the registered multimedia documents with the corresponding signatures of the given multimedia document, each following comparison being performed only if the previously compared signatures have revealed similarities, each comparison of signatures in cascade being performed only on signatures in a group of registered multimedia documents whose previously-compared signatures have revealed similarities with the signatures of the given multimedia document, the final result of the last comparison enabling a report to be drawn up containing the list of registered multimedia documents that have shown similarities with the given multimedia document as input.

The present invention relates to a method and a system for identifying and verifying the content of multimedia documents, and it can be applied in particular to ensuring that a work is being used properly, and to certifying that the content of a multimedia document conforms with the content of a reference multimedia document.

Computer networks such as the Internet give authors the advantage of being able to disseminate their works and make them known quickly.

However, because of the ease of access, and because of the downloading and dissemination of information via the World Wide Web, the property rights of those same authors are threatened by dishonest persons seeking to disseminate illegal copies or to counterfeit a work. Honest people can also sometimes find themselves in illegal situations due to lack of understanding of copyright when they disseminate content for which they have not paid the corresponding rights. Illegal infringement and transfer of documents are becoming more and more widespread (pedophilia, depositing dubious documents in private locations (gateways), disseminating/selling copies of works, . . . ). These practices are increasing with increasing numbers of users of the network and with the feeling of impunity they have due to the assumed anonymity of electronic transactions. Images and sounds are copied and made available on the web sites of “Mr. Everyman”. It is thus easy to find artists' photographs or works of art, pieces of music in MP3, jingles, or iconographic elements which have been blithely plundered and perhaps also transformed without the consent of their authors. It is now commonplace, for example, to find entire films on the web that have been copied from private DVDs or even picked up using a video camera in a movie theater, . . . . Private (point-to-point) and public exchange formats are becoming ever more numerous.

The authorities responsible for keeping the Internet clean or for ensuring the works in their charge are used in legal manner find themselves defenseless because of the large volume of data available on the Internet and because of its fast rate of increase (doubling every year).

The invention seeks to make it possible in particular to detect and identify infringements of copyright or other rights of authors in works present on the Internet or on other information media (CDs, hard disks, etc.). The invention also makes it possible to identify transit over the Internet of works that are of a private nature. The invention also seeks to make it possible to certify the content of a document and thus to keep control over the exchange and use of information available on computer networks.

In general manner, an object of the invention is to enable the content of multimedia documents to be identified and verified more quickly and reliably, even when handling a large number of documents.

These objects are achieved by a method of identifying and verifying the content of multimedia documents accessible in a distributed system having multiple entry points,

the method being characterized in that it comprises:

a) a step of registering multimedia documents as identified works, this registration step comprising extracting a digital fingerprint from each multimedia document taken into consideration and storing said digital fingerprint in a database independent of the database in which the multimedia document might be archived, the digital fingerprint of the multimedia document under consideration comprising an ordered sequence of signatures in cascade resulting from multi-criterion analysis and breaking down into component parts of the multimedia document under consideration; and

b) a step of verifying whether a given multimedia document accessible to the public constitutes authorized or unauthorized use of the registered work,

this verification step comprising making successive comparisons using the signatures in cascade of the registered multimedia documents with corresponding signatures of the given multimedia document, the signature of the given multimedia document corresponding to an analysis criterion under consideration for a given comparison being computed immediately prior to making the comparison, and the following comparison being performed only if the previously compared signatures have revealed similarities, each comparison of signatures in cascade being performed only on the signatures of a group of registered multimedia documents whose previously-compared signatures have revealed similarities with the signatures of the given multimedia document, the final result of the last comparison enabling a report to be drawn up containing the list of registered multimedia documents that have revealed similarities with the given multimedia document as input.

The invention also provides a method of managing client databases containing a set of client multimedia documents, the method being characterized in that it comprises:

a) a step of registering multimedia documents as identified works, this registration step comprising extracting a digital fingerprint from each multimedia document taken into consideration and storing said digital fingerprint in a database independent of the database in which the multimedia document might be archived, the digital fingerprint of the multimedia document under consideration comprising an ordered sequence of signatures in cascade resulting from multi-criterion analysis and breaking down into component parts of the multimedia document under consideration; and

b) a step of verifying and certifying true matching between the content of client multimedia documents and the content of multimedia documents registered as identified works, the verification and certification step comprising:

b1) initially extracting a digital fingerprint for each client multimedia document, the digital fingerprint comprising an ordered sequence of signatures in cascade resulting from analysis and breaking down into component parts of the multimedia document under consideration; and

b2) making successive comparisons using the signatures in cascade of registered multimedia documents and the corresponding signatures of the digital fingerprints of each of the client multimedia documents, each comparison of signatures in cascade being performed only on those signatures of a group of registered multimedia documents for which the previously-compared signatures have revealed similarities with the signatures of the client multimedia document under consideration, the final result of the last comparison enabling a report to be drawn up for establishing a certificate that the content is a true match or that it is not in compliance depending on the degree of similarity observed between the client multimedia documents and the pre-registered multimedia documents.

In all cases, in an aspect of the invention, the ordered sequence of signatures in cascade comprises a first signature constituting an attention-catching signature based on a fast comparison criterion.

In another aspect of the invention, the ordered sequence of signatures in cascade comprises signatures representing overall characteristics of a registered multimedia document and signatures representing local characteristics of the registered multimedia document under consideration.

According to a particular characteristic, a signature of the ordered sequence of signatures in cascade constituting a digital fingerprint of a registered multimedia document under consideration itself constitutes a signature in cascade applied to an individual medium of the registered multimedia document or to a homogeneous component of an individual medium of the registered multimedia document.

The method of identifying and verifying the content of multimedia documents may also comprise a step of monitoring a network such as an intranet or the Internet to reveal multimedia documents for verification that are accessible to the public and that present content satisfying at least one criterion that has served to define the digital fingerprints of multimedia documents that have already been registered as identified works, and to identify an address for each multimedia document for verification that has been found in this way.

The invention also provides a system for identifying and verifying the content of multimedia documents accessible in a distributed system having multiple entry points, the system being characterized in that it comprises an interconnection and intercommunication platform co-operating with: a segmentation module for dissecting the content of a multimedia document; a fingerprint generator for generating a digital fingerprint of a multimedia document, the digital fingerprint of the multimedia document comprising an ordered sequence of signatures in cascade resulting from multi-criterion analysis and breaking down into components of the multimedia document under consideration; a notifier agent; a database of reference digital fingerprints; a content-tracking manager; a content-tracking subscriber; and a reference directory.

This system for identifying and verifying the content of multimedia documents may further comprise at least one of the following elements: a monitor agent; a subscriber manager; a certifier agent.

Other characteristics and advantages of the invention appear from the following description of particular embodiments, given as examples and with reference to the accompanying drawings, in which:

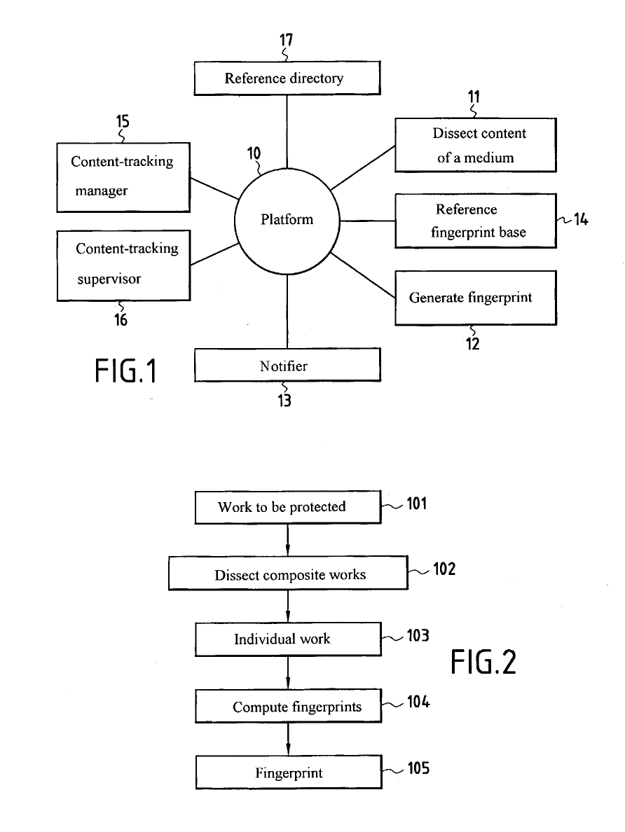

FIG. 1 is a block diagram of an example of the system of the invention for identifying and verifying the content of multimedia documents;

FIG. 2 is a flow chart showing the principal steps in generating a digital signature for a multimedia work to be protected in accordance with the invention;

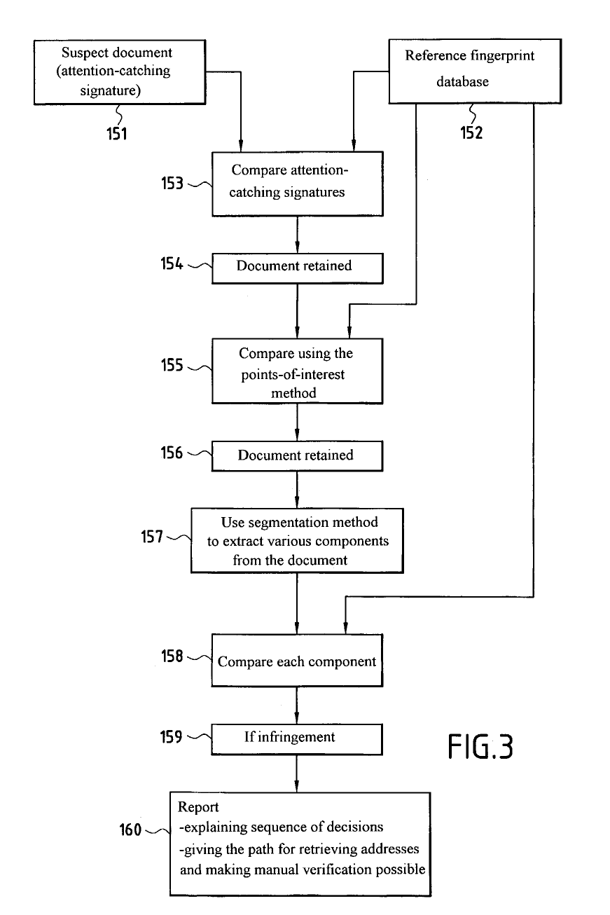

FIG. 3 is a flow chart showing an example of a method of the invention for identifying and verifying the content of multimedia documents as applied to monitoring on a computer network;

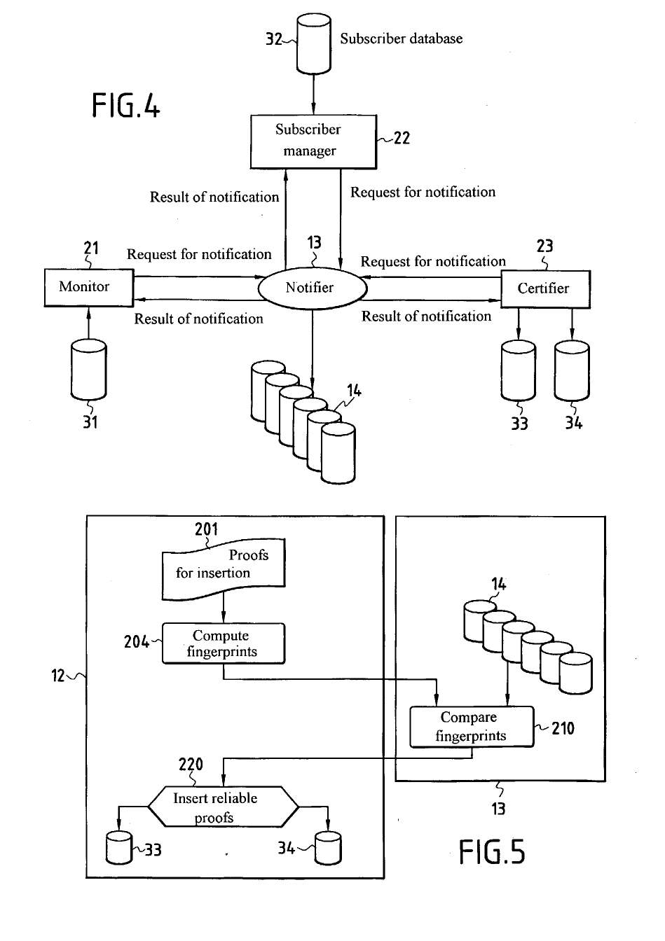

FIG. 4 is a block diagram showing the relationships between a plurality of functional units co-operating with a system for identifying and verifying the content of multimedia documents in accordance with the invention;

FIG. 5 is a flow chart showing a process for verifying documents (proofs) before they are inserted into a database of reliable documents, or into a database of dubious documents as a function of the result of the verification operation; and

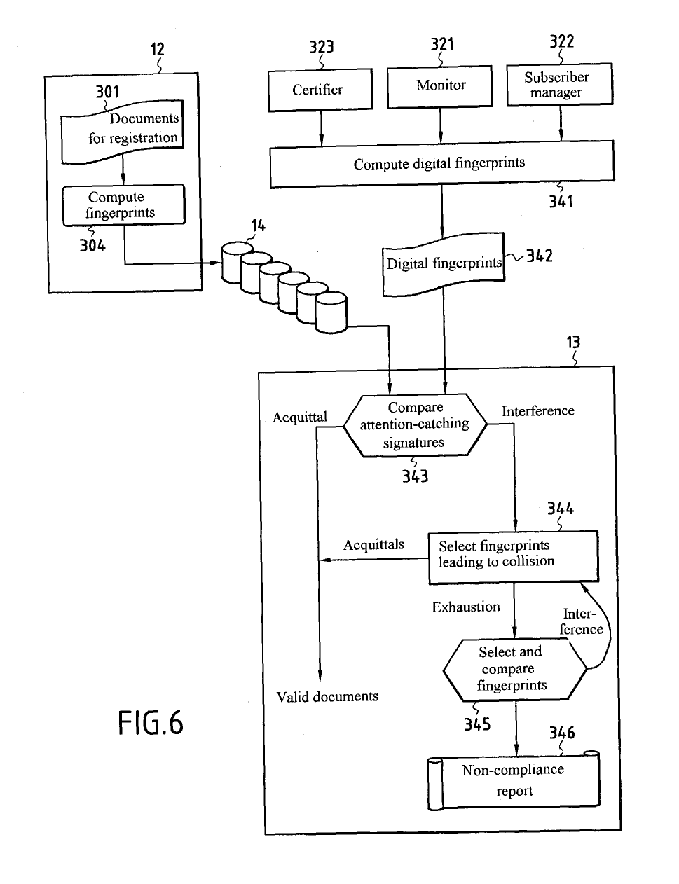

FIG. 6 is a general flow chart of an identification and verification method of the invention implementing processes for notifying and certifying documents.

The method of the invention for identifying and verifying the content of multimedia documents essentially implies a first step of registering multimedia documents as identified works, and a second step of verifying for a given multimedia document whether the content of the document matches in full or in part, or does not match the content of pre-registered multimedia documents so as to make it possible subsequently to deduce from said verification, for example, whether or not there have been any modifications or any utilizations differing in content from the reference multimedia documents.

The management method of the invention also makes it possible to manage subscriber databases or sites by verifying that their content is true and certifying it.

In particular, the invention makes it possible to verify whether a multimedia document accessible to the system on any medium or via a network such as the Internet corresponds to authorized use of a registered work and, where appropriate, to certify that the content of said document matches registered works. The method of the invention is thus particularly useful in settling questions raised in copyright law. The method makes it possible to use a metasearch engine associated with a concept dictionary to scan sites on a network and to monitor them thoroughly. It is thus possible to search for documents in which the content relates to at least one of the concepts of the dictionary.

In an important aspect of the invention, in order to register a work to be protected or in order to perform verification operations on multimedia documents, a digital fingerprint or synthesized signature is extracted from each multimedia document, thereby identifying each document and taking the place of that document in all subsequent processing. For multimedia documents that are to be registered, it thus suffices to store their digital fingerprints in reference databases without it being necessary to store the content of those documents in full, assuming that the digital fingerprint of each multimedia document in question is stored in a reference database that is independent from any database in which the multimedia document might happen to be archived.

More particularly, the digital fingerprint of the multimedia document in question comprises an ordered sequence of signatures in cascade that result from multi-criterion analysis and breakdown into component parts of the multimedia document under consideration.

Works registered with the system are protected against unauthorized use by comparing the digital fingerprint of each work registered in the system with the fingerprint extracted from documents stored on any media (CD, disk, DVD, . . . ) or in any site of the World Wide Web.

The system begins by dissecting the content of the documents or works of the site or medium in question.

The work may be an individual text, picture, piece of music, . . . , document, or it may be a composite document made up of a plurality of individual documents. The content of works may be stored in a site or on a CD, disk, DVD, . . . . The digital fingerprint or synthesized digital signature is generated in a plurality of steps as follows:

For each work of the medium, do:

1) read the content of the work and analyze the structure of the document;

2) if the content is composite, dissect the work and extract the components making up the content;

3) for each component, extract and produce its digital signature; and

4) build up a synthesized signature combining all of the information.

FIG. 2 sums up this process of generating a digital fingerprint or synthesizing a signature for a work.

The first step 101 consists in reading the document in question and in analyzing the structure of its content, the document in question possibly being provided by its author in order to constitute a registered protected work, or possibly being the result of tracking down documents on a network or a medium in the context of a monitoring operation, or possibly even being provided by a client for certification purposes, for example, or to check on its use.

If the document turns out to be composite, the second step 102 consists in segmenting or dissecting the multimedia document in question in order to extract the various homogeneous components or individual documents therefrom.

The third step 103 consists in isolating each individual document so as to proceed in step 104 with extracting and producing a digital signature for each individual document.

Step 105 consists in generating a digital fingerprint that constitutes a synthesized signature combining all of the information obtained during step 104 of producing a digital signature for each individual document.

Between step 104 and step 105, each individual document may, where appropriate, itself be broken up into homogeneous components so that a digital signature is established for each component. The process of generating a digital fingerprint for a multimedia document in the form of an ordered sequence of the signatures in cascade that result from the multi-criterion analysis and breaking down into component parts of the multimedia document is presented in greater detail below, with reference to implementations of each of the above-described steps of generating a digital signature.

The description begins with examples of reading the content of a document presented on an Internet site.

As its starting point, the system receives the standardized address of a page, its “URL”. The digital fingerprint of the page is computed in a plurality of steps:

1) local copying: the entry into the system is a URL which is analyzed:

a non-executable document: the document is loaded into the local machine;

an executable document (PHP, CGI): a copy of the execution is generated in a local document (stored in the form of a file or in the form of a computer “object” in the C++/JAVA meaning);

2) the agent for analyzing the structure of the document is identified and invoked: for example, analysis might be performed using an extension or a “magic word” or it might be of the MIME type in order to determine the nature of the document and invoke the appropriate indexing agent:

1. if the document is a monomedia document (image, video, audio, raw text) the document is sent to the indexing agent as a block of the corresponding type together with its URL;

if the document is of the shockwave type (swf, dcr) the document is sent to the SWF analyzer with its URL;

if the document is of the HTML type, the document is sent to the HTML analyzer with its URL;

if the document is of the VRML type, the document is sent to the VRML analyzer together with its URL;

if the document is a java applet, the document is sent to the java executor together with its URL;

if the document is a file associated with an activeX, the document is sent to the activeX executor with its URL;

if the document is a file associated with an external plug-in element, the document to be executed is sent to the plug-in element together with its URL.

An SWF type document is dissected in a plurality of steps:

a) the document is decompressed;

b) tags are extracted (thereby identifying images, videos, animations, etc.);

c) the corresponding text, image, etc., blocks are produced;

d) the relationships between said blocks are produced.

An HTML or VRML type document is dissected on the same principles as applied by the SWF analyzer, but with extended HTML or VRML constraints. Dissection of the result of a java/activeX/plug-in executor begins by capturing non-event execution in a document to be dissected

1) the indexer begins by creating a list (initially empty) of blocks containing a pointer to a local copy, a URL pointing to the original data, the type of the block (still image, animated image, etc.), and a unique identifier. It receives data coming from various services. For each object, it analyzes the subtype of the object on the basis of a list of formation rules and production rules which it applies in order to produce one or more blocks which are added to the list.

Example of a transformation rule:

animated-GIF rule: if (type is an animated GIF image) then apply:

1. extract each image;

2. save the images;

3. add one block for each image.

The step of dissecting or segmenting a composite multimedia work consists in breaking down the content of the composite document into component parts:

When dissecting a video work, the content of the video document is analyzed to produce a summary containing not only text and sound information from the video, but also images that are representative of the video sequences. The result is an XML document containing the URLs of the elements extracted from the video (the URL of the original document, the URL of the page of images representative of the video, the URL of the text, . . . ).

When dissecting an HTML page or a site, the content of the page is analyzed to identify and extract its various components (flash, film, image, text, audio, . . . ). Each of the components is then dissected in turn. The final result is an XML document combining the structure of the site with the URLs of the pages storing the information extracted from the site/page.

The invention also takes account of dissection of media having dynamic structure (i.e. including not only static data, but also executable code fragments: e.g. javascript code) or interactive media (CD-ROM, DVD, Flash). Documents of these types are more and more often present in multimedia content and they require analysis work that is more complex than the read/analysis mechanisms described above.

The problem with such media lies in the fact that the content of the media cannot be fully dissected into individual media merely by reading that content since portions of the content are not generated until execution, and sometimes those portions are generated solely in a manner that depends on interaction with a user. These two situations can be illustrated by two examples:

First example: code causing media to be included: javascript code within an HTML document can use concatenation to compute a URL for a link in the page, thereby deciding to include a medium whose description is not directly written in the HTML file. The description is indirect since it is produced only when the code is executed.

Second example: interactive code: the URL for the content of an HTML page is produced as a result of concatenation as in the first example, but in this case one of the terms of the concatenation depends on a selection made by the user. In this second case, not only is the description indirect, but it will not always be the same, depending on the selection made by the user.

For documents presenting these characteristics, an approximation is made to the behavior of the document program so as to characterize dynamic content and interactive media as well as possible. Various schemes can be used to produce such an approximation, depending on the intended purpose of the analysis. It is possible to use semantics that are operational, denotational, axiomatic, . . . . The approximation of such semantics followed by introducing properties by approximation makes it possible to transform a document describing potential inclusion of media into a set of potential documents exactly including a particular medium. Static analysis as described below constitutes one particular method given by way of example.

The abstract interpretation applied in the form of static analysis is performed under the form of ranges of values and/or sets of values that can be taken by the variables in the program at each step of the program:

if (a==2)

{b=“http://www.audio”}

else {b=“http://www.video”}

b will be described by the following set of values:

E(b)={b=“http://www.audio”, b=“http://www.video”}

A variable c to be selected by the user by means of a cursor graduated over a range −0.5 to +0.5 is described by the following range of values:

E(c)=[−0.5;+0.5]

The operations performed on these variables are approximated by the possible consequences of the range or the set of values for these actions.

Consider the following operation:

d=concatenation(b,“.html”).

Applying this operation to the above set:

E(b)={b=“http://www.audio”, b=“http://www.video”}

will produce the following set:

E(d)={b=“http://www.audio.html”, b=“http://www.video.html”}

Various techniques can be implemented for improving the convergence of such methods towards producing a result that is stable (referred to as “fixed points” in approximating semantics), for example by enlarging the range of variables, or narrowing it, breaking up ranges or sets into a plurality of subranges or subsets.

In order to optimize application of these methods, evolutionary strategy is implemented comparing proof solutions on which alternative strategies have been applied using an encoding scheme in a “genetic code” referred to as an “abstraction code”. Each of these solutions is processed in parallel, and the convergence of each solution is compared with that of the others. The best solutions (critical threshold or “elitism”, but other selection criteria could be applied) are retained and subjected to the action of mutation operators and bridging operators which mix the abstraction codes so as to converge as quickly as possible on fixed points.

The above evolutionary optimization scheme can be reduced to its simplest form (direct comparison of each of the methods of accelerating convergence).

The sets of potentialities represented by these fixed points represent media potentially inserted in the multimedia document. It is considered abstractly that the multimedia document contains all of these potentialities. The multimedia document to be indexed is thus a cloud of potentialities, and each of these potentialities is indexed with the document. The referencing system makes sure that the status of the “potentiality” is recorded in the meta-index so as to distinguish them from inclusions that are “certain”, and so as to characterize all inclusions as well as possible by means of a percentage (100% for inclusions that are certain, and otherwise a proportionally lower percentage depending on the ranges and the documents that might be included).

Static analysis of dynamic or interactive code is thus intended to extract “potential” links/media and to identify content in spite of the possibility of this content or these links being generated dynamically (at run time) by user actions.

The purpose of this task is to extract a mathematical characterization representing the work independently of the conditions under which the work was taken or digitized (lighting, position, . . . ). This is in order to be able to identify the presence of all or part of a work in various contexts (inlay, rotation, noise, . . . ). To do this, a signature is generated in cascade (nested signature). The signature in cascade represents both overall characteristics (color, shape, texture) and local characteristics (particular details). The signature in cascade is made up of a sequence of individual signatures associated with the methods used in producing individual signatures. Amongst the methods used for producing signatures in cascade, mention can be made of the following:

A) calorimetric quantification of the image and of homogeneous zones (homogeneous from the point of view of color): the result is a set of vectors representing the dominant colors of images and of their various components. The method is based on histogram analysis (M-dimensional vector respecting the distribution of colors in the image). The algorithm is as follows:

1. computing the colors of each of the strips of the image (HSV/RGB);

2. normalization: dividing the value of each sample by the sum of the values of all of the samples of the image. The resulting vector makes the histogram invariant in the face of various geometrical operations on the image (change of scale, rotation, . . . );

3. quantification of the histogram: producing a vector of small size that is less sensitive to picture-taking conditions. The elements of the vector are the parameters of a sequence of Gaussian distributions approximating the normalized histogram. Two methods are used:

a. the first is based on the Fisher algorithm (subdivision of the histogram into N classes), each class corresponding to homogeneous zones of the images;

b. the second is based on iterative computation. At each iteration, the parameterization of the Gaussian corresponding to the maxima of the Gaussian are estimated. The pixels whose values are covered by this Gaussian are labeled with the index of the iteration, and the values of the pixels are zeroed. The histogram is computed again and iteration is continued until all of the image points have been zeroed.

4. Compute and quantify the histogram of each of the zones of the image.

B) Characterizing zones of interest (salient points and zones or patterns constituting the components). One possible characterization method characterizes the neighborhoods of zones of interest and also the distribution obtained on the basis of points of interest.

C) Characterizing the positions of pixels belonging to the same entity (articles, shape, . . . ). This characterization depends on the complexity of the shapes of components of the image. Simple shapes such as straight lines, circles, . . . are described by the inherent equations. The method used for extracting circles and ellipses is based on contour detection and the spocke filter.

Complex shapes are described by a series of affine invariants which are determined on the basis of the positions of salient points. The method used is as follows:

1. calculate support points and outlines of components of the image;

2. sort salient points so as to retain only those which are positioned on outlines;

3. group salient points together and for each group compute the affine function approximating the curve passing through the salient points of the group.

D) Characterizing the visual appearance of the image and its components: it is possible to use a method based on breaking down into wavelets.

In the same manner as for a visual work, the digital fingerprint of a sound work is obtained in a plurality of steps: firstly, the work is broken down into a plurality of homogeneous components (homogeneous zone: same speaker, notes, same rhythm, . . . ). Then each of the homogeneous components is characterized, and finally the structure of the work is determined.

The digital fingerprint describes the content of a multimedia document. For a registered work generated by the system, fingerprints are stored in a database referred to the reference fingerprint base (RFB).

The content of a fingerprint is advantageously as follows:

1. composition of the work:

1. list of the individual works making up the document or work: a poster may be constituted by a plurality of photographs, more generally, a multimedia document is made up of a plurality of works, each having its own working conditions;

2. factual information: working conditions, authors, date, place, . . .

2. signatures in cascade for each of the individual works:

1. a chain of individual signatures and the methods used for producing each of them;

2. the spatial relationships between the components of an individual work;

3. the methods used for extracting these components;

4. the signature in cascade for each of the components of an individual work;

3. the attention-catching signature serving as an entry point to the fingerprint. It is this signature which is used in the initial stage of matching a document with the FRB database, it serves to confirm whether or not a document contains a work of the database or to indicate interference with the database. If so, the system refines the procedure of pairing elements of the document signature solely with the fingerprints of those works which have given rise to interference.

The method of the invention for identifying and verifying the content of multimedia documents is applied to multimedia documents accessible in a distributed system having multiple entry points.

The method can be used for monitoring purposes in order to reveal multimedia documents made available to the public which are likely to constitute wrongful use of pre-registered works and which present content satisfying at least one criterion that has been used for defining the digital fingerprints of multimedia documents already registered as identified works.

As mentioned above, a process for protecting a work takes place in two stages: the filing stage (registration) and the stage of monitoring proper use. To enable the works of authors who are dispersed around the world to be protected effectively and to facilitate the task of filing, and also to increase the effectiveness of the protection system, a content-tracking system of the invention is a distributed system having a plurality of entry points which may be distributed around the world. An author can register a work with one of the entry points to the system, and automatically the protection process is triggered to monitor whether this work is being worked under legal conditions. Thereafter the system makes it possible to detect unauthorized use of the work or of portions thereof.

In the filing stage, the work is registered at one or more entry points of the system. The system analyzes the work to extract a digital fingerprint which characterizes its content finely. As mentioned above, the digital fingerprint is made up of a signature characterizing the signal or the physical information of the work together with context information such as the name of the author, the date of creation, the type of work, . . . , and also the methods used for generating the signature.

During the monitoring stage, the digital fingerprint is used to identify and track down wrongful use of the work (presence of the work in another document, presence of the work on a non-authorized site, transformation and deformation of the work, . . . ). It is solely the digital fingerprint which needs to be stored in one of the databases of the content-tracking system, there is no need for the work itself to be saved in the system. The digital fingerprint can be extracted locally, but the digital fingerprint can subsequently be stored either locally or else remotely.

With reference to FIG. 1, there follows a description of the modules making up a minimum implementation of a system for identifying and verifying the content of multimedia documents, such as a system integrated in the above-described system for tracking content, for example.

The system for identifying and verifying the content of multimedia documents essentially comprises an interconnection and intercommunication platform 10 co-operating with: a segmentation module 11 for dissecting the content of a multimedia document; a fingerprint generator 12 for creating a digital fingerprint of a multimedia document; a notifier agent 13; a reference digital fingerprint database 14; a content-tracking manager 15; a content-tracking supervisor 16; and a reference directory 17.

The content-tracking manager 15 is used by the administrator to define the configuration of the system for tracking down content. It is distributed over the set of computation nodes participating in the configuration. One and only one instance is activated on each of the computation nodes.

The activated modules and the content-tracking manager 15 are registered in the reference directory 17. This directory 17 enables a module to retrieve the reference of another module from which it seeks to request a service on the basis of a generic name.

The platform 10 is made in application of standard protocols (CORBA, UDP/IP, TCP/IP, RTP/RTSP, HTTP, XML/SOAP) that are adapted to the needs of the application. Thus, for example, communication between agents (modules) situated in the same machine or in machines connected to the same local network make use of the CORBA, UDP/IP, or TCP/IP protocols. In contrast, communication between modules situated in machines that are connected via the Internet to two distinct networks can use the HTTP/XML/SOAP (simple object access protocol) protocols. This latter method of communication has the advantage of launching execution of a remote task by using the RCP (remote call protocol) protocol. Invocation of the task and transmission of its arguments are described by an XML page (where XML is an extension of HTML). Sending the page to the node (server) hosting the task causes the task to be executed. The result is sent to the sender in the form of an XML page. The advantage of invocation (execution) in this way lies on the fact that it is based only on the HTTP protocol and consequently is less constraining to implement.

FIG. 4 shows the modules or agents of the system of the invention which, once a reference database of documents 14 containing the digital fingerprints of pre-registered reference multimedia documents has been created, participate in the process of monitoring proper use of these pre-registered reference multimedia documents.

A notifier agent compares the fingerprint of documents that are entered and delivers a report concerning the matching of such documents with pre-registered works.

An explorer or monitor agent 21 has the function of identifying sites that might contain pre-registered works. It comprises a metasearch engine coupled with a concept dictionary 31. The metasearch engine scans the Internet looking for sites containing suspect documents (i.e. documents having content which corresponds to at least one of the concepts in the dictionary 31). The fingerprint of each of these documents is forwarded to the notifier 13 which compares the fingerprints of these documents with the fingerprints of the reference database 14 and delivers either a true-match certificate (acquittal) or else a non-compliance report. The explorer 21 enriches this report with information concerning sites holding these documents and also sites acting as accomplices (sites serving as relays in locating the document). This is for the purpose of providing the operator in charge of detecting fraud with all of the information needed for locating the target. Only the non-compliance report is forwarded to a human operator, and it does not contain any document. The documents are not conserved; they are used solely to compute digital fingerprints.

A subscriber manager 22 certifies the content of the documents issued by a subscriber database 32. It analyzes the content of the site passed as an argument and compares the fingerprints of these documents with those that have acquired the right to work them legally.

A content certifier agent 23 certifies the content of a site, a file, a CD, or some other medium. It co-operates with the notifier 13 in order to clean up the content of a site. On each insertion of a document (referred to as a “proof”) into the site, its content is analyzed and a compliance report is issued. This module is designed to be coupled to a content-distributing system. It co-operates with a reliable document database 33 and with a dubious document database 34.

The process of inserting proofs (multimedia documents to be analyzed and verified) into a reliable document database 33 or into a dubious document database 34 associated with the certifier agent 23 is described below with reference to FIG. 5.

This stage is technically similar to the stage of filing works, but it differs in the use that is made of the documents that have been analyzed. Pre-registered works represent documents which are to be protected, i.e. documents with which similarity comparisons are to be performed, e.g. in order to discover possible infringements or pirate copies. Proofs are documents that are to be tested to find out whether they are themselves infringements or pirate copies. Their signatures are computed in the same manner as for registered works (with the same four stages of reading/analysis, breaking down into component parts, individual signatures, composite signatures), but these signatures are put into a different database: the proof fingerprint database. This database may contain the fingerprint of a single document (content verification) or of a very large number of documents (database-to-database comparison). The fingerprint database is then forwarded to the notifier 23. The notifier compares the database of proof fingerprints with the database of reference fingerprints 32 and returns a report specifying, for each fingerprint, whether or not it matches a reference fingerprint. The proofs which are found to be positive (fingerprint at least similar to one or more of the reference fingerprints) are put into a dubious document database (DDDB) 34. The other proofs are put into a reliable document database (RDDB) 33. The insertion of documents into the DDDB 34 or into the RDDB 33 is not automatic and requires human intervention.

The RDDB 33 may contain a copy of the original documents of the proofs, together with associated information enabling them to be found and possibly also serving as proof (http address, etc.). The copy can be used, for example, by a certified repeat dissemination database for the application concerning information repeat disseminators. It is cleaned of its dubious elements by the system at the end of the process and can thus serve as a proxy or a server, for example.

The flow chart of FIG. 5 shows proofs for insertion being introduced at an input (step 201) of the fingerprint generator 12, a step 204 of computing the fingerprints of the proofs that have been input, a comparison step 210 performed within the notifier 13 to compare the fingerprints of the proofs computed in step 204 with the reference fingerprints contained in the reference fingerprint database 14, and a sorting step 220 for inserting the fingerprints of proofs either into the reliable document database 33 or into the dubious document database 34 as a function of the result of the matching test performed in step 210.

The process of notifying, certifying, and managing subscribers or clients is shown in FIG. 6 in which there can be seen a step 301 of inputting multimedia documents for registration, a step 304 of computing the fingerprints of the documents to be registered by means of the fingerprint generator 12, which delivers digital fingerprints that are stored in the reference fingerprint database 14.

Documents to be checked can be input by a monitor agent 21 (step 321), by a subscriber manager 22 (step 322), or by a certifier 23 (step 323) These documents for checking are subjected to digital fingerprint computation in step 341, with their digital fingerprints being applied in a step 342 to the notifier 13 for comparison with the fingerprints in the reference fingerprint database 14.

In step 343, a first comparison is performed between the first signatures of the fingerprints to be compared, these first signatures constituting attention-catching signatures which are preferably based on a fast comparison criterion.

At the end of step 343, the result is either an acquittal, with the document to be checked being considered as valid and not affecting any pre-registered reference document, or else, in the event of interference between the attention-catching signatures of the compared documents, the method moves onto a step 344 in which fingerprints of the reference database 14 that have led to the collision are selected, after which the method moves onto a step 345 in which further comparisons are made between lower level individual signatures of the cascade of signatures constituting the fingerprint of a document to be checked and the same-level individual signatures in the cascade of signatures constituting the fingerprints of the reference documents selected in the preceding step 344. The process is reiterated between steps 345 and 344 so long as interference is observed and until there are no more individual signatures or reference documents. Acquittal is possible during each step 344. If after the last comparison in step 345 there is no acquittal, then a non-compliance report is issued in step 366.

Thus, after comparing the fingerprints of the documents to be checked with those of the reference fingerprint database, a true-match certificate or a non-compliance report is delivered. Once the fingerprints received as inputs have been compared with those of the reference database 14 to the desired level of precision, the system produces a decision as to whether the documents to be checked are valid, invalid, or doubtful. This decision can take three distinct forms depending on the application.

For an application in which the monitor agent 21 is tracking down content that is illegal or pirated, this will lead to a notification stage. For a content-validating application run by the certifier agent 23 (e.g. for content repeat disseminators), this will lead to a certification stage. For a subscriber management application run by the subscriber manager 22, this will lead to a reporting procedure.

When tracking down illegal content, thus leading to a notification procedure, a positive result (finding a document from the proof database in the registered works database 14) during the comparison stage leads to a mechanism being run to verify this result. This mechanism is intended to eliminate false alarms and takes place in two stages. The first stage consists in refining the comparison using higher level terms of the signature (where the terms are selected as a function of the computation time available and the sizes of the two databases being compared, in application of a linear relationship). Comparing these higher level terms is more expensive in computation time and should therefore be performed only on a subset of the elements in each of the databases: the (work/proof) pairs for which a positive result has been produced. The set of result pairs is then sorted by order of decreasing maximum similarity at the highest level of precision, and then at decreasing levels of precision. The second stage of the process consists in comparing the (work/proof) pairs in said list in terms of common components and in determining which proofs are most suspect in order of decreasing similarity in order to produce a list of the N most similar proofs (where N is set by the operator).

This second stage may be no more than cutting off the list of pairs sorted in decreasing order so as to retain only the N first elements (where N is set by the operator).

Once this list has been obtained, together with the fingerprint information associated with each of its elements, it constitutes the result that is output by the system under these circumstances.

In the context of a specification procedure, the production of a positive result during the comparison stage can lead to a validation stage identical to that described above, but that is not essential. When the validation stage is not performed, an ordered list of suspect (work/proof) pairs is drawn up on the basis of decreasing similarity. This list or the list produced after refinement is used to cause the corresponding files to be deleted from the proof database and for warning messages to be issued or for a report containing said list to be sent to the operator. Once the doubtful files have been deleted, the proof database is said to be declared certified.

In the context of a procedure using the subscriber manager 22, the purpose is to ensure that the content of subscriber sites (i.e. sites having a subscription contract) are in compliance, i.e. a document is issued specifying the works over which the subscriber has acquired working rights. The subscriber manager scans subscriber sites one by one for each site. For each site visited, it analyzes its content (in co-operation with the notifier 13). For each non-compliant document not mentioned in the subscription contract, a reporting procedure can be undertaken.

FIG. 3 is a flow chart showing an example of a verification process applies to a suspect document found while tracking down content or supplied from a particular medium, the suspect document then being compared with pre-registered documents.

In this case, the reference fingerprints of the various pre-registered documents are initially computed and stored in a reference fingerprint embodiment (step 152).

The suspect document for verification is itself subjected to computation to determine a high level first signature (attention-catching signature) in step 151.

A first comparison is then made between the attention-catching signature of the suspect document and the attention-catching signatures of the reference fingerprints in the reference database 152 (step 153).

If, as a result of this first comparison between attention-catching signatures, the suspect document is considered as being close to certain pre-registered reference documents (step 154), these pre-registered reference documents are retained for further comparison, with the new comparison being performed between signatures at a level lower than the previously used attention-catching signature. At this lower level, which may correspond, for example, to generating individual signatures using the method of points of interest, the corresponding signature of the suspect document is generated and then this signature is compared with the corresponding same-level signatures that have already been stored in the reference database, belonging to the pre-registered documents that were retained at the end of step 153.

If following the comparison in step 155 the suspect document is still considered as being close to certain pre-registered reference documents (step 156), these reference documents are retained for a further comparison performed between signatures at an even lower level which may correspond, for example, to generating individual signatures following a segmentation method for extracting the various components of the document, and in this case also, the corresponding signature of the suspect document is generated for each component (step 157) and these signatures are compared with the corresponding same-level signatures stored in the reference database, for the pre-registered documents that were retained at the end of step 155.

If at the end of the step 158 comparing the suspect document is considered as constituting an infringement, for example, given the similarities that have been detected, then a report is issued, for example, explaining the sequence of decisions taken and giving the path for recovering the addresses that will make manual verification possible.

1/ A method of identifying and verifying the content of multimedia documents accessible in a distributed system having multiple entry points,
the method being characterized in that it comprises:
a) a step of registering multimedia documents as identified works, this registration step comprising extracting a digital fingerprint from each multimedia document taken into consideration and storing said digital fingerprint in a database independent of the database in which the multimedia document might be archived, the digital fingerprint of the multimedia document under consideration comprising an ordered sequence of signatures in cascade resulting from multi-criterion analysis and breaking down into component parts of the multimedia document under consideration; and
b) a step of verifying whether a given multimedia document accessible to the public constitutes authorized or unauthorized use of the registered work,
this verification step comprising making successive comparisons using the signatures in cascade of the registered multimedia documents with corresponding signatures of the given multimedia document, the signature of the given multimedia document corresponding to an analysis criterion under consideration for a given comparison being computed immediately prior to making the comparison, and the following comparison being performed only if the previously compared signatures have revealed similarities, each comparison of signatures in cascade being performed only on the signatures of a group of registered multimedia documents whose previously-compared signatures have revealed similarities with the signatures of the given multimedia document, the final result of the last comparison enabling a report to be drawn up containing the list of registered multimedia documents that have revealed similarities with the given multimedia document as input.

2/ A method according to claim 1, characterized in that the ordered sequence of signatures in cascade comprises a first signature constituting an attention-catching signature based on a fast comparison criterion.

3/ A method according to claim 2, characterized in that the ordered sequence of signatures in cascade comprises signatures representing overall characteristics of a registered multimedia document and signatures representing local characteristics of the registered multimedia document under consideration.

4/ A method according to claim 1, characterized in that a signature of the ordered sequence of signatures in cascade constituting a digital fingerprint of a registered multimedia document under consideration itself constitutes a signature in cascade applied to an individual medium of the registered multimedia document or to a homogeneous component of an individual medium of the registered multimedia document.

5/ A method according to claim 1, characterized in that it further comprises a step of monitoring a network such as an intranet or the Internet to reveal multimedia documents for verification that are accessible to the public and that present content satisfying at least one criterion that has served to define the digital fingerprints of multimedia documents that have already been registered as identified works, and to identify an address for each multimedia document for verification that has been found in this way.

6/ A system for identifying and verifying the content of multimedia documents accessible in a distributed system having multiple entry points,
the system being characterized in that it comprises an interconnection and intercommunication platform co-operating with: a segmentation module for dissecting the content of a multimedia document; a fingerprint generator for generating a digital fingerprint of a multimedia document, the digital fingerprint of the multimedia document comprising an ordered sequence of signatures in cascade resulting from multi-criterion analysis and breaking down into components of the multimedia document under consideration; a notifier agent; a database of reference digital fingerprints; a content-tracking manager; a content-tracking subscriber; and a reference directory.

7/ A system according to claim 6, characterized in that it further comprises a subscriber manager.

8/ A system according to claim 6, characterized in that it further comprises a certifier agent.

9/ A system according to claim 8, characterized in that it further comprises a monitor agent.

10/ A method of managing client databases containing a set of client multimedia documents, the method being characterized in that it comprises:
a) a step of registering multimedia documents as identified works, this registration step comprising extracting a digital fingerprint from each multimedia document taken into consideration and storing said digital fingerprint in a database independent of the database in which the multimedia document might be archived, the digital fingerprint of the multimedia document under consideration comprising an ordered sequence of signatures in cascade resulting from multi-criterion analysis and breaking down into component parts of the multimedia document under consideration; and
b) a step of verifying and certifying true matching between the content of client multimedia documents and the content of multimedia documents registered as identified works, the verification and certification step comprising:
b1) initial extracting a digital fingerprint for each client multimedia document, the digital fingerprint comprising an ordered sequence of signatures in cascade resulting from analysis and breaking down into component parts of the multimedia document under consideration; and
b2) making successive comparisons using the signatures in cascade of registered multimedia documents and the corresponding signatures of the digital fingerprints of each of the client multimedia documents, each comparison of signatures in cascade being performed only on those signatures of a group of registered multimedia documents for which the previously-compared signatures have revealed similarities with the signatures of the client multimedia document under consideration, the final result of the last comparison enabling a report to be drawn up for establishing a certificate that the content is a true match or that it is not in compliance depending on the degree of similarity observed between the client multimedia documents and the pre-registered multimedia documents.

11/ A method according to claim 10, characterized in that the ordered sequence of signatures in cascade comprises a first signature constituting an attention-catching signature based on a fast comparison criterion.

12/ A method according to claim 10, characterized in that the ordered sequence of signatures in cascade comprises signatures representing overall characteristics of a registered multimedia document and signatures representing local characteristics of the registered multimedia document under consideration.

13/ A method according to claim 10, characterized in that a signature of the ordered sequence of signatures in cascade constituting the digital fingerprint of a registered multimedia document under consideration itself constitutes a signature in cascade applied to an individual medium of the registered multimedia document or to a homogeneous component of an individual medium of the registered multimedia document.
